(19) United States
(12) Patent Application Publication
(10) Pub. No.: US 2021/0264285 A1
(43) Pub. Date: Aug. 26, 2021

(54) DETECTING DEVICE, DETECTING METHOD, AND DETECTING PROGRAM

(71) Applicant: NIPPON TELEGRAPH AND TELEPHONE CORPORATION, Tokyo (JP)

(72) Inventors: Hiroshi TAKAHASHI, Musashino-shi, Tokyo (JP); Tomoharu IWATA, Musashino-shi, Tokyo (JP); Yuki YAMANAKA, Musashino-shi, Tokyo (JP); Masanori YAMADA, Musashino-shi, Tokyo (JP); Satoshi YAGI, Musashino-shi, Tokyo (JP)

(73) Assignee: NIPPON TELEGRAPH AND TELEPHONE CORPORATION, Tokyo (JP)

(21) Appl. No.: 17/253,131

(22) PCT Filed: Jun. 19, 2019
(86) PCT No.: PCT/JP2019/024297

§ 371 Date: Dec. 17, 2020

(30) Foreign Application Priority Data
Jun. 20, 2018 (JP) 2018-116796

(51) Int. Cl. G06N 3/08; G08B 5/22; H04Q 9/00; G06N 3/04

(52) U.S. Cl. CPC G06N 3/088; G08B 5/22; G16Y 10/75; G06N 3/0454; H04Q 9/00

(57) ABSTRACT

An acquisition unit (15a) acquires data output by sensors. A learning unit (15b) substitutes a prior distribution of an encoder in a generative model including the encoder and a decoder and representing a probability distribution of the data with a marginalized posterior distribution that marginalizes the encoder, approximates a Kullback-Leibler information quantity using a density ratio between a standard Gaussian distribution and the marginalized posterior distribution, and learns the generative model using data. A detection unit (15c) estimates a probability distribution of the data using the learned generative model and detects an event in that an estimated occurrence probability of the data newly acquired is lower than a prescribed threshold as abnormality.

### TECHNICAL FIELD

The present invention relates to a detection device, a detection method, and a detection program.

### BACKGROUND ART

In recent years, with popularization of so-called IoT for connecting various objects such as vehicles and air conditioners to the Internet, a technique of detecting abnormality or failure in an object in advance using sensor data of sensors attached to the object has attracted attention. For example, an abnormal value indicated by sensor data is detected using machine learning to detect a sign that abnormality or failure occurs in the object. That is, a generative model that estimates a probability distribution of data by machine learning is created, and abnormality is detected in such a way that data with a high occurrence probability is defined as normal and data with a low occurrence probability is defined as abnormal.

VAE (Variational AutoEncoder) which is a generative model for machine learning using latent variables and a neural network is known as a technique of estimating a probability distribution of data (see NPL 1 to 3). VAE is applied in various fields such as abnormality detection, image recognition, video recognition, and audio recognition in order to estimate a probability distribution of large-scale and complex data. In VAE, it is generally assumed that a prior distribution of latent variables is a standard Gaussian distribution.

### CITATION LIST

### Non Patent Literature

[NPL 1] Diederik P. Kingma, Max Welling, “Auto-Encoding Variational Bayes”, [online], May 2014, [Retrieved on May 25, 2018], Internet <URL: https://arxiv.org/abs/1312.6114>[NPL 2] Matthew D. Hoffman, Matthew J. Johnson, “ELBO surgery: yet another way to carve up the variational evidence lower bound”, [online], 2016, Workshop in Advances in Approximate Bayesian Inference, NIPS 2016, [Retrieved on May 25, 2018], Internet <URL: http://approximateinference.org/2016/accepted/HoffmanJohnson20 16.pdf>[NPL 3] Jakub M. Tomczak, Max Welling, “VAE with a VampPrior”, [online], 2017, arXiv preprint arXiv:1705.07120, [Retrieved on May 25, 2018], Internet <URL: https://arxiv.org/abs/1705.07120>

### SUMMARY OF THE INVENTION

### Technical Problem

However, in conventional VAE, when a prior distribution of latent variables is assumed to be a standard Gaussian distribution, estimation accuracy of a probability distribution of data is low.

The present invention has been made to solve the above-described problems, and an object thereof is to estimate a probability distribution of data according to VAE with high accuracy.

### Means for Solving the Problem

In order to solve the problems and attain the object, a detection device according to the present invention includes: an acquisition unit that acquires data output by sensors; a learning unit that substitutes a prior distribution of an encoder in a generative model including the encoder and a decoder and representing a probability distribution of the data with a marginalized posterior distribution that marginalizes the encoder, approximates a Kullback-Leibler information quantity using a density ratio between a standard Gaussian distribution and the marginalized posterior distribution, and learns the generative model using data; and a detection unit that estimates a probability distribution of the data using the learned generative model and detects an event in that an estimated occurrence probability of the data newly acquired is lower than a prescribed threshold as abnormality.

### Effects of the Invention

According to the present invention, it is possible to estimate a probability distribution of data according to VAE with high accuracy.

### BRIEF DESCRIPTION OF DRAWINGS

FIG. 1 is an explanatory diagram for describing an overview of a detection device.

FIG. 2 is a schematic diagram illustrating a schematic configuration of a detection device.

FIG. 3 is an explanatory diagram for describing processing of a learning unit.

FIG. 4 is an explanatory diagram for describing processing of a detection unit.

FIGS. 5(a) and 5(b) are explanatory diagrams for describing processing of a detection unit.

FIG. 6 is a flowchart illustrating a detection processing procedure.

FIG. 7 is a diagram illustrating a computer executing a detection program.

### DESCRIPTION OF EMBODIMENTS

Hereinafter, an embodiment of the present invention will be described in detail with reference to the drawings. However, the present invention is not limited to this embodiment. In the drawings, the same elements are denoted by the same reference numerals.

[Overview of Detection Device]

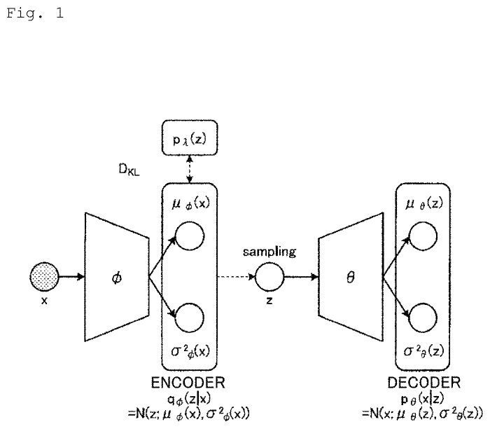

A detection device of the present embodiment creates a generative model based on VAE to detect abnormality in sensor data of IoT. FIG. 1 is an explanatory diagram for describing an overview of a detection device. As illustrated in FIG. 1, VAE includes two conditional probability distributions called an encoder and a decoder.

An encoder q₁₀₀ (z|x) encodes high-dimensional data x to convert the same to an expression using low-dimensional latent variables z. Here, φ is a parameter of the encoder. A decoder pθ(x|z) decodes the data encoded by the encoder to reproduce original data x. Here, θ is a parameter of the decoder. When the original data x is continuous values, a Gaussian distribution is generally applied to the encoder and the decoder. In the example illustrated in FIG. 1, a distribution of the encoder is N(z;μ_{θ}(x),σ²φ(x)) and a distribution of the decoder is N(x;μ_{θ}(z),σ²θ(z)).

Specifically, as illustrated in Formula 1 below, VAE reproduces a probability distribution p_{D}(x) of true data as p_{θ}(x). Here, p_{λ}(z) is called a prior distribution and is generally assumed to be a standard Gaussian distribution having an average of μ=0 and a variance of σ²=1.

[Formula 1]

pθ=∫p₀(x|z)p_{λ}(z)dz (1)

VAE performs learning so that a difference between a true data distribution and a data distribution based on a generative model is minimized. That is, a generative model of VAE is created by determining the encoder parameter φ and the decoder parameter θ so that the average of logarithmic likelihoods corresponding to a likelihood indicating the recall ratio of a decoder is maximized. These parameters are determined when a variational lower bound indicating a lower bound of the logarithmic likelihood is maximized. In other words, in learning of VAE, the parameters of the encoder and the decoder are determined so that the average of loss functions obtained by multiplying variational lower bounds by minus 1 is minimized.

Specifically, in VAE learning, as illustrated in Formula 2, parameters are determined so that the average of marginalized logarithmic likelihoods lnp_{θ} (x) that marginalize logarithmic likelihoods is maximized.

$$\begin{matrix}[ Formula 2 ] & \\ {max}_{θ} \int {p}_{D} ( x ) ln {p}_{θ} ( x ) dx & ( 2 )\end{matrix}$$

As illustrated in Formula 3, a marginalized logarithmic likelihood is suppressed from below by a variational lower bound.

$$\begin{matrix}[ Formula 3 ] & \\ \begin{matrix}ln {p}_{θ} ( x ) = ln {𝔼}_{{q}_{ϕ} ( z \vert x )} [ \frac{{p}_{θ} ( x \vert z ) {p}_{λ} ( z )}{{q}_{ϕ} ( z \vert x )} ] \\ \geq {𝔼}_{{q}_{ϕ} ( z \vert x )} [ ln \frac{{p}_{θ} ( x \vert z ) {p}_{λ} ( z )}{{q}_{ϕ} ( z \vert x )} ] \\ = ℒ ( θ , ϕ ; x )\end{matrix} & ( 3 )\end{matrix}$$

That is, a variational lower bound of a marginalized logarithmic likelihood is represented by Formula 4.

[Formula 4]

[symbol]

(θ,ϕ,X)=E_{q}_{_{φ}}_{(z|x)}[Inp_{θ}(x|z)]−D_{KL}(q_{ϕ}(z|x)∥p_{λ}(z) (4)

wherein [symbol] is a variational lower bound.

The first term (assigned with a minus sign) in Formula 4 is called a reconstruction error. The second term is called a Kullback-Leibler information quantity of the encoder q_{φ}(z|x) with respect to the prior distribution p_{λ}(z). As illustrated in Formula 4, a variational lower bound can be interpreted as a reconstruction error normalized by a Kullback-Leibler information quantity. That is, the Kullback-Leibler information quantity can be said to be a term that normalizes so that the encoder q_{φ}(z|x) approaches the prior distribution pλ(z). VAE performs learning so that the first term is increased and the Kullback-Leibler information quantity of the second term is decreased to maximize the average of marginalized logarithmic likelihoods.

However, as described above, it is known that, although a prior distribution is assumed to be a standard Gaussian distribution, in this case, this assumption may interrupt the learning of VAE and the estimation accuracy of a probability distribution of data is low. In contrast, a prior distribution optimal to VAE can be obtained by analysis.

Therefore, in a detection device of the present embodiment, as illustrated in Formula 5, a prior distribution is substituted with a marginalized posterior distribution q_{φ}(z) that marginalizes the encoder q₁₀₀ (z|x) (see NPL 2).

[Formula 5]

∫p_{D}(x)q_{ϕ}(z|x)dx≡q_{ϕ}(z) (5)

On the other hand, when the prior distribution p_{λ}(z) is substituted with the marginalized posterior distribution q_{φ}(z), it is difficult to obtain a Kullback-Leibler information quantity of the encoder q_{φ}(z|x) with respect to the marginalized posterior distribution q_{φ}(z) by analysis. Therefore, in the detection device of the present embodiment, a Kullback-Leibler information quantity is approximated using a density ratio between a standard Gaussian distribution and a marginalized posterior distribution so that the Kullback-Leibler information quantity can be approximated with high accuracy. In this way, a VAR model of VAE capable of estimating a probability distribution of data with high accuracy is created.

[Configuration of Detection Device]

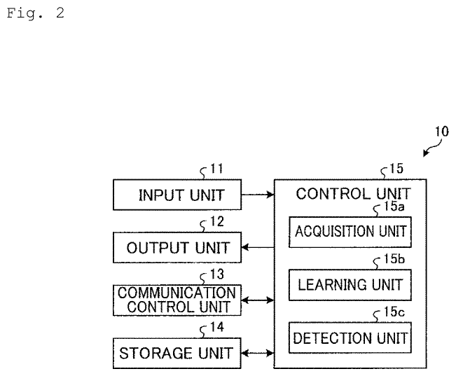

FIG. 2 is a schematic diagram illustrating a schematic configuration of a detection device. As illustrated in FIG. 2, a detection device 10 is realized as a general-purpose computer such as a PC and includes an input unit 11, an output unit 12, a communication control unit 13, a storage unit 14, and a control unit 15.

The input unit 11 is realized using an input device such as a keyboard or a mouse and inputs various pieces of instruction information such as start of processing to the control unit 15 according to an input operation of an operator. The output unit 12 is realized as a display device such as a liquid crystal display and a printer.

The communication control unit 13 is realized as a NIC (Network Interface Card) or the like and controls communication with the control unit 15 and an external device such as a server via a network 3.

The storage unit 14 is realized as a semiconductor memory device such as a RAM (Random Access Memory) or a Flash Memory or a storage device such as a hard disk or an optical disc and stores parameters of a generative model of data learned by a detection process to be described later. The storage unit 14 may communicate with the control unit 15 via the communication control unit 13.

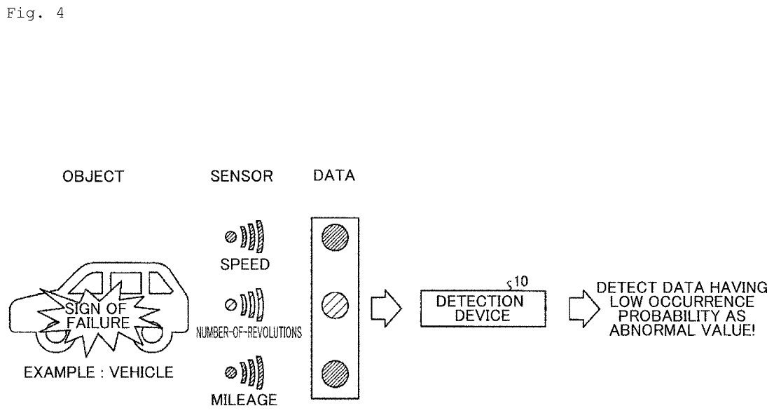

The control unit 15 is realized using a CPU (Central Processing Unit) and executes a processing program stored in a memory. In this way, the control unit 15 functions as an acquisition unit 15a, a learning unit 15b, and a detection unit 15c as illustrated in FIG. 4. These functional units may be implemented in different hardware components.

The acquisition unit 15a acquires data output by sensors. For example, the acquisition unit 15a acquires sensor data output by sensors attached to an IoT device via the communication control unit 13. Examples of sensor data include data of temperature, speed, number-of-revolutions, and mileage sensors attached to a vehicle and data of temperature, vibration frequency, and sound sensors attached to each of various devices operating in a plant.

The learning unit 15b substitutes a prior distribution of an encoder in a generative model including the encoder and a decoder and representing a probability distribution of the data with a marginalized posterior distribution that marginalizes the encoder, approximates a Kullback-Leibler information quantity using a density ratio between a standard Gaussian distribution and the marginalized posterior distribution, and learns the generative model using data.

Specifically, the learning unit 15b creates a generative model representing an occurrence probability distribution of data on the basis of VAE including an encoder and a decoder following a Gaussian distribution. In this case, the learning unit 15b substitutes the prior distribution of the encoder with a marginalized posterior distribution q_{φ}(z) that marginalizes the encoder illustrated in Formula 5. The learning unit 15b approximates the Kullback-Leibler information quantity of the encoder q_{φ}(z|x) with respect to the marginalized posterior distribution q_{φ}(z) by estimating a density ratio between the standard Gaussian distribution p(z) having an average of ρ=0 and a variance of σ²=1 and the marginalized posterior distribution q_{φ}(z).

Here, density ratio estimation is a method of estimating a density ratio between two probability distributions without estimating the two probability distributions. Even when the respective probability distributions are not obtained by analysis, when sampling from the respective probability distributions can be performed, since the density ratio between the two probability distributions can be obtained, it is possible to apply the density ratio estimation.

Specifically, the Kullback-Leibler information quantity of the encoder q_{φ}(z|x) with respect to the marginalized posterior distribution q_{φ}(z) can be decomposed into two terms as illustrated in Formula 6.

$$\begin{matrix}[ Formula 6 ] & \\ \begin{matrix}{D}_{K L} ( {q}_{ϕ} ( z \vert x ) ‖ {q}_{ϕ} ( z ) ) ) = \int {q}_{ϕ} ( z \vert x ) ln \frac{{q}_{ϕ} ( z \vert x )}{{q}_{ϕ} ( z )} d z \\ = \int {q}_{ϕ} ( z \vert x ) ln \frac{{q}_{ϕ} ( z \vert x )}{{q}_{ϕ} ( z )} \frac{p ( z )}{p ( z )} d z \\ = \int {q}_{ϕ} ( z \vert x ) ln \frac{{q}_{ϕ} ( z \vert x )}{p ( z )} d z + \\ \int {q}_{ϕ} ( z \vert x ) ln \frac{p ( z )}{{q}_{ϕ} ( z )} d z \\ = {D}_{K L} ( {q}_{ϕ} ( z \vert x ) ‖ p ( z ) ) ) - {𝔼}_{{q}_{ϕ} ( z \vert x )} [ ln \frac{{q}_{ϕ} ( z )}{p ( z )} ]\end{matrix} & ( 6 )\end{matrix}$$

In Formula 6, the first term is a Kullback-Leibler information quantity of the encoder q_{φ}(z|x) with respect to the standard Gaussian distribution p(z) and can be calculated by analysis. The second term is represented using the density ratio between the standard Gaussian distribution p(z) and the marginalized posterior distribution q_{φ}(z). In this case, since sampling from the marginalized posterior distribution q_{φ}(z) as well as from the standard Gaussian distribution p(z) can be performed easily, it is possible to apply density ratio estimation.

Although it is known that estimation accuracy of a density ratio is low for high-dimensional data, since the latent variable z of VAE is low-dimensional, it is possible to estimate the density ratio with high accuracy.

Specifically, as illustrated in Formula 7, T(z) that maximizes an objective function which uses a function T(z) of z is defined as T*(z). In this case, as illustrated in Formula 8, T*(z) is equal to the density ratio between the standard Gaussian distribution p(z) and the marginalized posterior distribution q_{φ}(z).

$$\begin{matrix}[ Formula 7 ] & \\ {T}^{*} ( z ) = {max}_{T} \{ {𝔼}_{{q}_{ϕ} ( z )} ln ( σ ( T ( z ) ) ) + {𝔼}_{p ( z )} ln ( 1 - σ ( T ( z ) ) ) \} & ( 7 ) \\ [ Formula 8 ] & \\ {T}^{*} ( z ) = ln \frac{{q}_{ϕ} ( z )}{p ( z )} & ( 8 )\end{matrix}$$

Therefore, as illustrated in Formula 9, the learning unit 15b performs approximation that substitutes the density ratio of the Kullback-Leibler information quantity illustrated in Formula 6 with T*(z).

[Formula 9]

D_{KL}(q_{ϕ}(z))=D_{KL}(q_{ϕ}(z|x)∥(z))− [symbol] _{qϕ(z|x)}[T*(z)] (9)

In this way, the learning unit 15b can approximate the Kullback-Leibler information quantity of the encoder q_{φ}(z|x) with respect to the marginalized posterior distribution q_{φ}(z) with high accuracy. Therefore, the learning unit 15b can create the generative model of VAE capable of estimating a probability distribution of data with high accuracy.

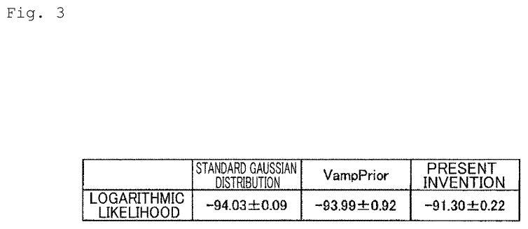

FIG. 3 is an explanatory diagram for describing processing of the learning unit 15b. FIG. 3 illustrates logarithmic likelihoods of generative models learned by various methods. In FIG. 3, a standard Gaussian distribution represents conventional VAE. Moreover, VampPrior represents VAE in which latent variables have a mixture distribution (see NPL 3). Moreover, a logarithmic likelihood is a measure of accuracy evaluation of a generative model, and the larger the value, the higher the accuracy. In the example illustrated in FIG. 3, a logarithmic likelihood is calculated using a MNIST dataset which is sample data of handwritten numbers.

As illustrated in FIG. 3, it can be understood that due to the method of the present invention illustrated in the embodiment, the value of a logarithmic likelihood increases and the accuracy is improved as compared to the conventional VAE and VampPrior. In this way, the learning unit 15b of the present embodiment can create a high-accuracy generative model.

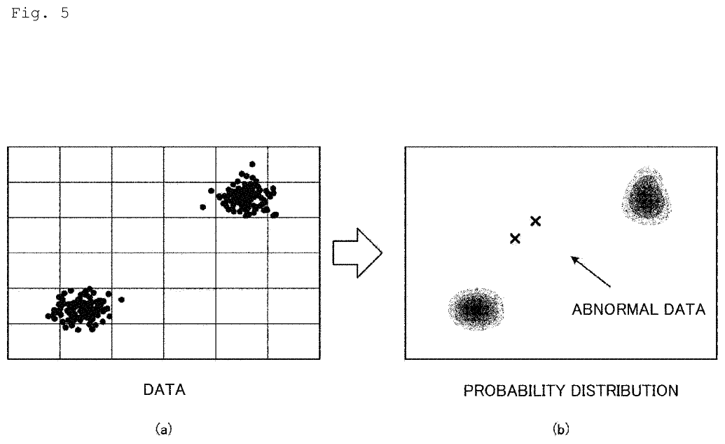

Returning to description of FIG. 2, the detection unit 15c estimates a probability distribution of the data using the learned generative model and detects an event in that an estimated occurrence probability of the data newly acquired is lower than a prescribed threshold as abnormality. For example, FIGS. 4 and 5 are explanatory diagrams for describing the processing of the detection unit 15c. As illustrated in FIG. 4, in the detection device 10, the acquisition unit 15a acquires data of speed, number-of-revolutions, and mileage sensors attached to an object such as a vehicle, and the learning unit 15b creates a generative model representing a probability distribution of the data.

The detection unit 15c estimates an occurrence probability distribution of data using the created generative model. The detection unit 15c determines that data newly acquired by the acquisition unit 15a is normal when an estimated occurrence probability is equal to or larger than a prescribed threshold and is abnormal when the probability is lower than the prescribed threshold.

For example, as illustrated in FIG. 5(a), when data indicated by points in a two-dimensional data space is given, the detection unit 15c estimates an occurrence probability distribution of data using the generative model created by the learning unit 15b as illustrated in FIG. 5(b). In FIG. 5(b), the thicker the color on the data space, the higher the occurrence probability of data in that region. Therefore, data having a low occurrence probability indicated by x in FIG. 5(b) can be regarded as abnormal data.

The detection unit 15c outputs a warning when abnormality is detected. For example, the detection unit 15c outputs a message or an alarm indicating detection of abnormality to a management device or the like via the output unit 12 or the communication control unit 13.

[Detection Process]

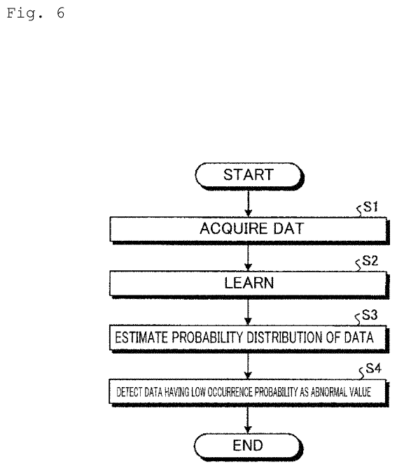

Next, a detection process of the detection device 10 according to the present embodiment will be described with reference to FIG. 6. FIG. 6 is a flowchart illustrating a detection processing procedure. The flowchart of FIG. 6 starts at a timing at which an operation input instructing the start of a detection process, for example.

First, the acquisition unit 15a acquires data of speed, number-of-revolutions, and mileage sensors attached to an object such as a vehicle (step S1). Subsequently, the learning unit 15b leans a generative model including an encoder and a decoder following a Gaussian distribution and representing a probability distribution of data using the acquired data (step S2).

In this case, the learning unit 15b substitutes the prior distribution of the encoder with a marginalized posterior distribution that marginalizes the encoder. Moreover, the learning unit 15b approximates a Kullback-Leibler information quantity using a density ratio between the standard Gaussian distribution and the marginalized posterior distribution.

Subsequently, the detection unit 15c estimates an occurrence probability distribution of the data using the created generative model (step S3). Moreover, the detection unit 15c detects an event in that an estimated occurrence probability of the data newly acquired by the acquisition unit 15a is lower than a prescribed threshold as abnormality (step S4). The detection unit 15c outputs a warning when abnormality is detected. In this way, a series of detection processes ends.

As described above, in the detection device 10 of the present embodiment, the acquisition unit 15a acquires data output by sensors. Moreover, the learning unit 15b substitutes a prior distribution of an encoder in a generative model including the encoder and a decoder and representing a probability distribution of data with a marginalized posterior distribution that marginalizes the encoder, approximates a Kullback-Leibler information quantity using a density ratio between a standard Gaussian distribution and the marginalized posterior distribution, and learns the generative model using data. The detection unit 15c estimates a probability distribution of data using the learned generative model and detects an event in that an estimated occurrence probability of the data newly acquired is lower than a prescribed threshold as abnormality.

In this way, the detection device 10 can create a high-accuracy data generative model by applying density ratio estimation which uses low-dimensional latent variables. In this manner, the detection device 10 can learn a generative model of large-scale and complex data such as sensor data of IoT devices. Therefore, it is possible to estimate an occurrence probability of data with high accuracy and detect abnormality in the data.

For example, the detection device 10 can acquire large-scale and complex data output by various sensors such as temperature, speed, number-of-revolutions, and mileage sensors attached to a vehicle and can detect abnormality occurring in the vehicle during travel with high accuracy. Alternatively, the detection device 10 can acquire large-scale and complex data output by temperature, vibration frequency, and sound sensors attached to each of various devices operating in a plant and can detect abnormality with high accuracy when abnormality occurs in any one of the devices.

The detection device 10 of the present embodiment is not limited to that based on the conventional VAE. That is, the processing of the learning unit 15b may be based on AE (Auto Encoder) which is a special case of VAE and may be configured such that an encoder and a decoder follow a probability distribution other the Gaussian distribution.

[Program]

A program that describes processing executed by the detection device 10 according to the embodiment in a computer-executable language may be created. As an embodiment, the detection device 10 can be implemented by installing a detection program that executes the detection process as package software or online software in a desired computer. For example, by causing an information processing device to execute the detection program, the information processing device can function as the detection device 10. The information processing device mentioned herein includes a desktop or laptop-type personal computer. In addition, mobile communication terminals such as a smartphone, a cellular phone, or a PHS (Personal Handyphone System), and a slate terminal such as a PDA (Personal Digital Assistant) are included in the category of the information processing device.

The detection device 10 may be implemented as a server device in which a terminal device used by a user is a client and which provides a service related to the detection process to the client. For example, the detection device 10 is implemented as a server device which receives data of sensors of IoT devices as input and provides a detection process service of outputting a detection result when abnormality is detected. In this case, the detection device 10 may be implemented as a web server and may be implemented as a cloud that provides a service related to the detection process by outsourcing. An example of a computer that executes a detection program for realizing functions similar to those of the detection device 10 will be described.

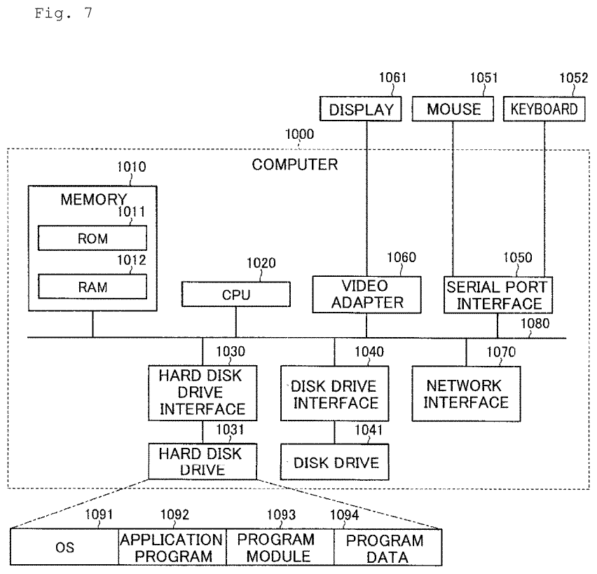

FIG. 7 is a diagram illustrating an example of a computer that executes the detection program. A computer 1000 includes, for example, a memory 1010, a CPU 1020, a hard disk drive interface 1030, a disk drive interface 1040, a serial port interface 1050, a video adapter 1060, and a network interface 1070. These elements are connected by a bus 1080.

The memory 1010 includes a ROM (Read Only Memory) 1011 and a RAM 1012. The ROM 1011 stores a boot program such as a BIOS (Basic Input Output System), for example. The hard disk drive interface 1030 is connected to a hard disk drive 1031. The disk drive interface 1040 is connected to a disk drive 1041. A removable storage medium such as a magnetic disk or an optical disc is inserted into the disk drive 1041. A mouse 1051 and a keyboard 1052, for example, are connected to the serial port interface 1050. For example, a display 1061 is connected to the video adapter 1060.

Here, the hard disk drive 1031 stores an OS 1091, an application program 1092, a program module 1093, and program data 1094, for example. Various types of information described in the embodiment are stored in the hard disk drive 1031 and the memory 1010, for example.

The detection program is stored in the hard disk drive 1031 as the program module 1093 in which commands executed by the computer 1000 are described, for example. Specifically, the program module 1093 in which respective processes executed by the detection device 10 described in the embodiment are described is stored in the hard disk drive 1031.

The data used for information processing by the detection program is stored in the hard disk drive 1031, for example, as the program data 1094. The CPU 1020 reads the program module 1093 and the program data 1094 stored in the hard disk drive 1031 into the RAM 1012 as necessary and performs the above-described procedures.

The program module 1093 and the program data 1094 related to the detection program are not limited to being stored in the hard disk drive 1031, and for example, may be stored in a removable storage medium and be read by the CPU 1020 via the disk drive 1041 and the like. Alternatively, the program module 1093 and the program data 1094 related to the detection program may be stored in other computers connected via a network such as a LAN (Local Area Network) or a WAN (Wide Area Network) and be read by the CPU 1020 via the network interface 1070.

While an embodiment to which the invention made by the present inventor has been described, the present invention is not limited to the description and the drawings which form a part of the disclosure of the present invention according to the present embodiment. That is, other embodiments, examples, operation techniques, and the like performed by those skilled in the art based on the present embodiment fall within the scope of the present invention.

### REFERENCE SIGNS LIST

10 Detection device
11 Input unit
12 Output unit
13 Communication control unit
14 Storage unit
15 Control unit
15a Acquisition unit
15b Learning unit
15c Detection unit

1. A detection device comprising:
acquisition circuitry that acquires data output by sensors;
learning circuitry that substitutes a prior distribution of an encoder in a generative model including the encoder and a decoder and representing a probability distribution of the data with a marginalized posterior distribution that marginalizes the encoder, approximates a Kullback-Leibler information quantity using a density ratio between a standard Gaussian distribution and the marginalized posterior distribution, and learns the generative model using data; and
detection circuitry that estimates a probability distribution of the data using the learned generative model and detects an event in that an estimated occurrence probability of the data newly acquired is lower than a prescribed threshold as abnormality.

2. The detection device according to claim 1, wherein the encoder and the decoder follow a Gaussian distribution.

3. The detection device according to claim 1,
wherein the detection circuitry outputs a warning when abnormality is detected.

4. A detection method, comprising:
acquiring data output by sensors;
substituting a prior distribution of an encoder in a generative model including the encoder and a decoder and representing a probability distribution of the data with a marginalized posterior distribution that marginalizes the encoder, approximating a Kullback-Leibler information quantity using a density ratio between a standard Gaussian distribution and the marginalized posterior distribution, and learning the generative model using data; and
estimating a probability distribution of the data using the learned generative model and detecting an event in that an estimated occurrence probability of the data newly acquired is lower than a prescribed threshold as abnormality.

5. A non-transitory computer readable medium including a detection program for causing a computer to execute:
acquiring data output by sensors;
substituting a prior distribution of an encoder in a generative model including the encoder and a decoder and representing a probability distribution of the data with a marginalized posterior distribution that marginalizes the encoder, approximating a Kullback-Leibler information quantity using a density ratio between a standard Gaussian distribution and the marginalized posterior distribution, and learning the generative model using data; and
estimating a probability distribution of the data using the learned generative model and detecting an event in that an estimated occurrence probability of the data newly acquired is lower than a prescribed threshold as abnormality.
